(19) United States
(12) Patent Application Publication
(10) Pub. No.: US 2001/0020231 A1
(43) Pub. Date: Sep. 6, 2001

(54) Marketing System and Method

(75) Inventors: Mr. Peter Perri III, Jupiter, FL (US); Mr. Richard L. Braman Jr., Fort Lauderdale, Florida (US)

Correspondence Address: Jonathan C. Parks, Kirkpatrick & Lockhart LLP, Henry W. Oliver Building, 535 Smithfield Street, Pittsburgh, Pennsylvania, 15222, US, 412-355-6288, 412-355-6501

(73) Assignee: DesktopDollars.com, Fort Lauderdale, 33301 (US)

(21) Appl. No.: 09/557,484

(22) Filed: Apr. 24, 2000

(51) Int. Cl. G06F 17/60

(52) U.S. Cl. 705/14

(57) ABSTRACT

### Abstract of Disclosure

A computer assisted compensation method is provided. The compensation method comprises sending a message from a first party to a second party, wherein the message includes a link to a processor and the link has a sponsor identifier, having the second party select the link to contact the processor, correlating the first party with the second party, and providing credit to the first party for an activity of the second party. A compensation system and an apparatus that performs a compensation function are also provided. A computer assisted marketing method is also provided. The computer assisted marketing method includes identifying a referrer, correlating a referred consumer and the referrer that referred the consumer, receiving referred consumer purchase information, calculating compensation due to the referrer for referred consumer activity, transferring consumer activity related data to a merchant storage device, and transferring consumer activity related data to a non-merchant storage device. A marketing system and an apparatus that performs a marketing function are also provided.

### Cross Reference to Related Applications

Not Applicable

### Federal Research Statement

Not Applicable

### Background of Invention

Field of the Invention

The present invention relates to promoting sales and, more particularly, to an automated marketing system and method for providing an incentive in exchange for a referral.

Description of the Invention Background

Merchants face an enduring problem of creating awareness of their products and services with the consumers that desire the products and services. Even the best product or service cannot be sold unless the potential customers of that product are aware of the product's existence and the source of the product. Therefore, many methods have been developed for attracting the attention of potential customers to particular products. Traditional methods of attracting necessary attention include media advertising, direct mail and personal interaction. More recently, the World Wide Web portion of the Internet has been utilized as a medium for advertising. Those methods, however, are used by many merchants and have thus saturated the consuming public with such a large quantity of information that consumers are becoming overloaded with more information than they can retain. Consumers, therefore, block out much of the advertising information with which they are constantly bombarded. Advertising media are also in great demand and have become very costly. Furthermore, determining which media will reach a merchant's target audience is difficult but necessary because advertising that does not reach the target audience is wasted.

When personal interaction is utilized in advertising, a commission has commonly been paid to a salesperson for either informing the consumer about the product and the source of the product or for selling the product. Commissions come in many forms, including payment of a percentage of the sale. Sales made through commission programs, however, are also very costly and often ineffective. An employee must be attracted by offering adequate earning potential and other benefits. In addition, the employee must generally either travel to meet potential customers or be provided with space which must be rented or purchased in an area to which potential customers will be attracted. The cost associated with such an employee, travel and space are often prohibitively high, such that desirable products are sometimes never sold because the cost of each sale is greater than may be borne by the sales price of the product.

Multi-level marketing, wherein an independent contractor collects a commission on products that the contractor sells and also recruits other independent contractors on whose sales he or she also collects a commission, has been used with limited success. A disadvantage to multi-level marketing for a merchant is the amount of accounting required to track the commission to be paid to each independent contractor. Disadvantages for the independent contractor include the time required to make sales and recruit other independent contractors, overcoming the discomfort of making sales pitches, usually in person to acquaintances, and the cost of purchasing and storing a stock of merchandise.

One way that Internet marketing professionals currently approach the problem of driving users to their web sites is through the use of banner ads that use click-through methods. For example, marketers may place a banner at the top of another's web site that allows users of that web site to click on the banner ad to access the marketer's company web site. That method of marketing and advertising is widely used, but is also very expensive. Such a method can be ineffective and inefficient because the company must pay for the banner ads regardless of whether customers actually purchase anything from the advertiser's web site, i.e., it is a "sunk cost." In that way, the banner ad method is similar to that used by traditional advertisers, such as those placing commercials on TV programs. Therefore, the users of banner ads are simply taking traditional means of advertising and adapting them to the Internet.

A second method used to drive "traffic" and business to a web site is an affiliate program. The term "traffic" is intended to describe the number of consumers that access, purchase from or otherwise interface with a web site or a merchant's advertising or sales media. An affiliate program is a program that allows a web site owner to place a link to, for example, a product and/or a service and receive a commission for purchases made that resulted from a user selecting a link on the affiliate program participant's web site. Affiliate programs solve the problem of not paying out advertising dollars until a purchase is actually made. However, affiliate programs are only available to people that have a web site, or have the knowledge to set one up. Also, an affiliate program will only be effective if the advertising web site can actually drive enough traffic to the advertised web site to make the program an effective advertising medium. Therefore, the banner ad method is often inefficient and the affiliate program method is often ineffective.

Thus, there is a need for a cost-effective system and a method of attracting potential purchasers to a processor which may be connected to the World Wide Web, and to the goods and/or services of a merchant that may be available through that processor. Thus, there is a particular need for a cost effective system and method of attracting purchasers by referrals over the World Wide Web.

There is also a need for a cost-effective system and a method of attracting members for organizations and a particular need to attract registered members to sites providing goods and services over the World Wide Web.

There is a further need for a cost-effective system and method to entice those potential purchasers to make purchases from particular providers and to entice those potential members to become members of particular organizations.

### Summary of Invention

In accordance with one form of the present invention, there is provided a computer assisted compensation method, comprising sending a message from a first party to a second party, wherein the message includes a link to a processor and the link has a sponsor identifier, having the second party select the link to contact the processor, correlating the first party with the second party, and providing credit to the first party for an activity of the second party.

A compensation system is also provided. The compensation system includes a processor and a memory device in communication with the processor, the memory device having data and instructions stored thereon which, when executed by the processor, cause the processor to send a message to a first party for forwarding to a second party, wherein the message includes a link to a processor and the link has a sponsor identifier, receive an inquiry from the second party, wherein said inquiry is initiated by the second party selecting the link, correlate the sponsor identifier of the first party with an activity of the second party, and provide credit to the first party for an activity of the second party.

A computer readable medium is also provided, wherein the computer readable medium has instructions stored thereon which, when executed by a processor, cause said processor to send a message to a first party for forwarding to a second party, wherein the message includes a link to the processor and the link has a sponsor identifier, receive an inquiry from the second party, wherein the inquiry is initiated by the second party selecting the link, correlate the sponsor identifier of the first party with an activity of the second party, and provide credit to the first party for activity of the second party.

In addition, a computer assisted marketing method is provided. The computer assisted marketing method includes identifying a referrer, correlating a referred consumer and the referrer that referred the consumer, receiving referred consumer purchase information, calculating compensation due to the referrer for referred consumer activity, transferring consumer activity related data to a merchant storage device, and transferring consumer activity related data to a non-merchant storage device.

A marketing system is also provided. The marketing system includes a processor and a memory device in communication with the processor, the memory device has data and instructions stored thereon which, when executed by the processor, cause the processor to identify a referrer, correlate a referred consumer and the referrer that referred the consumer, receive information regarding contact the consumer has with at least one merchant, calculate compensation due to the referrer for the contact with the at least one merchant, transfer data related to consumer contact with the at least one merchant to a merchant storage device, and transfer data related to consumer contact with the at least one merchant to a non-merchant storage device.

It is a feature of the present marketing system that the system entices people to recommend a participating merchant. Another feature of the present marketing system is that it eliminates the need for traditional advertising that requires expenditure of money prior to sales and, furthermore, has a cost that is directly related to an increase in sales attributable to the advertising. The marketing system is cost effective because the costs cannot be greater than the revenue derived due to the fact that the cost of the solution is defined as a percentage of the revenue derived from the solution and payment may be made after actual sales or viewing of the merchant's goods and/or services has occurred.

The present invention beneficially does not require that an advertiser have a web site to participate such that many people can participate in the advertising.

The present invention also personalizes individual advertisements to improve response to the advertisements.

The present invention beneficially converts visitors to members at a high ratio, because the user is compensated for his membership. Banner ads, in contrast, may drive traffic to a site, but do not provide an incentive for getting visitors to become registered members.

The invention described herein also differs from other solutions, because it solves a highly prevalent problem on the Internet of "stickiness." "Stickiness" refers to the ability of a site to induce repeat visits. The present invention provides an incentive for the member to return to the site to earn more compensation and/or to determine how much compensation they have earned through people they have referred.

The present invention beneficially uses a medium that is widely available to a large population, recognizes that the issues surrounding the Internet are different from traditional commercial mediums and provides a solution that accommodates those differences. Accordingly, the present invention provides solutions to the shortcomings of conventional marketing and incentive systems and methods. Those of ordinary skill in the art will appreciate, however, that these and other details, features and advantages will become further apparent as the following detailed description proceeds.

### Brief Description of Drawings

In the accompanying Figures, there are shown present preferred embodiments of the invention wherein like reference numerals are employed to designate like parts and wherein:

Figure 1 is a diagram illustrating a three-party marketing system of the present invention;

Figure 2 is a flow diagram illustrating an embodiment of the marketing system of Figure 1;

Figure 3 is a diagram illustrating an embodiment of the member registration module of Figure 2;

Figure 4 illustrates an embodiment of a member registration form;

Figure 5 is a diagram illustrating an embodiment of the business logic module of Figure 2;

Figure 6 illustrates a sample registration database having five records each of which contain twelve fields;

Figure 7 illustrates an embodiment of a flow through the membership registration module of Figure 2;

Figure 8 illustrates an embodiment of a sample registration database having four records that include sponsor identifier-related data;

Figure 9 illustrates an embodiment of a sample registration database having five records that include non-required information;

Figure 10 is a flow diagram illustrating an embodiment of a flow through the member referral module of Figure 2;

Figure 11 is a flow diagram illustrating referral mechanisms of the member referral module of Figure 2;

Figure 12 is a diagram illustrating a process flow through the referral gateway of Figure 11;

Figure 13 is a diagram illustrating an embodiment of the member compensation module of Figure 2;

Figure 14A is a flow diagram illustrating a level 1 calculation in a multi-level member compensation module;

Figure 14B is a flow diagram illustrating a level 2 calculation in a multi-level member compensation module;

Figure 14C is a flow diagram illustrating a level 3 calculation in a multi-level member compensation module;

Figure 14D is a flow diagram illustrating a level 4 calculation in a multi-level member compensation module;

Figure 14E is a flow diagram illustrating a level 5 calculation in a multi-level member compensation module;

Figure 14F is a flow diagram illustrating a level 6 calculation in a multi-level member compensation module;

Figure 15 illustrates sample compensation database entries utilized in connection with the member compensation module of Figure 2;

Figure 16 illustrates an embodiment of a flow through the member reporting module of Figure 2;

Figure 17A and 17B illustrate a flow through the member reporting module of Figure 1;

Figures 18A and 18B illustrate a flow through the member compensation module of Figure 1;

Figure 19 illustrates a sample compensation report of Figure 16; and

Figure 20 illustrates a sample referral report of Figure 16.

### Detailed Description

It is to be understood that the embodiments of the present invention that are described herein are illustrative only and are not exhaustive of the manners of embodying the present invention. For example, specific details of the operating system, database system, computer hardware, networking equipment and related items are not provided herein. Those components are well known in the art and those skilled in the art will recognize that the present invention may operate in connection with a variety of software and hardware platforms. It will also be recognized that the present invention may be utilized alone or in various combinations with systems and methods discussed herein and with other systems and methods not discussed herein.

The marketing system of the present invention is an interface between consumers and merchants to facilitate transactions. The system provides an incentive for people to contact the merchant in the future and to recommend the merchant to others. Thus, a purpose of the present system is to increase traffic at the media of one or more merchants. The particular media described herein is a web site on the World Wide Web portion of the Internet. When a user accesses a web site, that contact is referred to as a "hit." A "hit" on a particular web site or web page is registered each time the web site or page is accessed. The present invention, however, is not intended to be limited to use in connection with such a web site and may, for example, be used in connection with more traditional media, telephone, or personal contact. The present system is described in connection with sales made via the World Wide Web, but is not intended to be limited to sales or use on the World Wide Web.

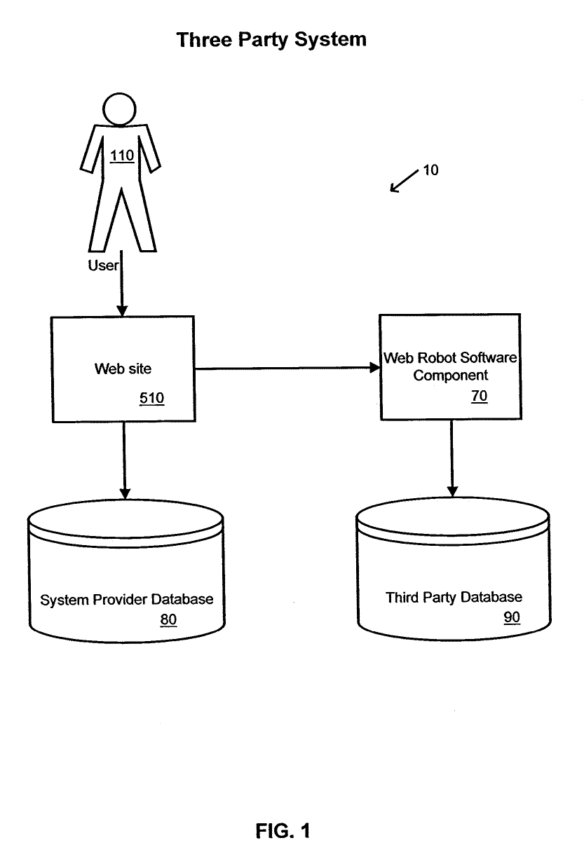

Referring now to the figures for the purposes of illustrating the present preferred embodiments of the invention only and not for the purposes of limiting the same, Figure 1 is a diagram illustrating a three-party viral marketing system 10, wherein consumers and merchants interact through a viral marketing provider. Alternatively, the marketing system 10 may be provided directly by the merchant. The system depicted in Figure 1 includes a user 110 accessing a web site 510 having access to a system provider database 80 and a third party database 90 by way of a web robot software 70. The web robot software 70 provides the following third party merchant functionality. In the three-party system illustrated, one or more consumers contact the merchant by, for example, accessing a web site through which the merchant's goods and/or services may be purchased. Once the consumer has accessed the web site, the consumer may purchase those goods or services, or may participate in desired on-line activities such as viewing or listening to advertisements and may also access the present marketing system. The consumer may also participate in the web site by becoming a member of that site and referring others to the site. The consumer may furthermore receive credit for his own participation in the web site and for referring others to the web site.

A feature of the present invention is that all information pertinent to member credit may be stored at both a marketer computer and a merchant computer. In that way, the merchant has access to pertinent information on demand for personal use and as a check on the marketer. Likewise, the marketer has access to the information both as a check on the merchant, to assure that members are awarded appropriate credit, and to administer the system.

An advantage of the present system to merchants is that a marketer may create and administer the system in connection with an existing merchant web site with little effort required on the part of the merchant. The merchant may simply add a link from the merchant's current web site to the system. The system may then provide the system screens discussed herein, while retaining the merchant's web site border such that the screen continues to have the look and feel of the merchant's web site. The member may also return to the merchant web site when the desired system transaction has been completed.

Tracking the referral information and credit due to each member may also be a highly involved task. A system may be devised wherein commission is paid to the referring members for referrals that stem both directly and indirectly from the referring member. For example, an original referring member may receive commission on sales or hits on a web site of a participating merchant made by those referred directly by the referring member. Furthermore, the original referring member may receive commission on sales or hits on a web site of a participating merchant made by indirect referrals. Second level indirect referrals occur when a referred person or entity refers one or more other persons or entities. When such a second level referral occurs, a commission may be paid to both the original referring member and the direct referring member. A commission may also be paid for third and other additional levels of indirect referral. Accordingly, a referring member may receive commissions on numerous sales and/or hits made by thousands of directly and indirectly referred consumers. It should be noted that there would normally be many referring members acting independently of other referring members as well as many members acting at varying levels in each referral network. The ability of a member to receive a commission on such a large number of contacts is a great incentive to engage in making referrals. The complexity of tracking and accounting for referrals at multiple levels, however, is a complex task requiring an extensive database and software programming to organize the data in the database. Thus, an advantage to the present system is that the merchant need merely to add access to the marketing system from the merchant's existing web site while the marketing system database and software programming operates on separate computing equipment operated by the marketing system provider.

It is also an advantage that the data from which commissions are calculated are saved both at the system computer and the merchant computer. In that way, a set of checks and balances are built into the system. The marketer may thereby perform the required calculations and distribute credit to members while the merchant possesses the data and can confirm sales and credit amounts. At the same time, members are protected from unscrupulous merchants by the marketer because the marketer is able to assure that appropriate credit is given to members, whereas a merchant might otherwise be tempted to under-calculate the credit.

Merchant contact data including, for example, sales and hits made by referred consumers, may be tracked directly by the marketer or may be transferred to the marketer by the merchant. Where contact data is collected by the marketer, the consumer may be directed to the merchant through the marketing system. For example, the consumer may contact the merchant and be directed to the marketing system where the merchant's goods and graphics are depicted while contact data is collected by both the marketer and the merchant. Alternatively, the consumer may enter the marketing system initially and proceed through the marketing system to the merchant site.

Purchases may also be conducted with the merchant through the marketer, with purchase data being forwarded to both the merchant and marketer databases. Directing sales data to both the merchant and marketer beneficially permits the marketer to process member credit while the merchant processes consumer shipping and billing. In that way, the merchant may continue processing shipping and billing as most merchants are accustomed to do, while the marketer handles the processing of data that is particular to the marketing system. The marketing system may include software code written in any suitable computer language such as, for example, C, C++, or Visual Basic using, for example, conventional or object-oriented programming techniques. The marketing software may operate on any suitable computer such as, for example, a server, an IBM® compatible PC, a mainframe computer, a mini-computer, an Apple® Macintosh® computer or a workstation. The software may operate in connection with any suitable operating system including, for example, Microsoft® Windows®NT, and any suitable database such as, for example, Microsoft® SQL Server®. The computer may furthermore be connected to the merchant and consumer by any suitable communications medium such as, for example, the Internet, an intranet, a local area network, a wide area network or a public switched telephone network (PSTN).

When the marketing system 10 is operated in connection with a web site, the marketing system may be accessed through a merchant's web site. A selectable rewards object may be included in the merchant's web site. The rewards object may, for example, read "send a friend," "earn money," or "earn clix," wherein "clix" are credits which can be accumulated and exchanged for money, goods or services, for example, as compensation for participating in the marketing system. When the consumer selects the rewards object, the consumer is presented with a rewards program web page. The rewards program web page offers several options which may include, but are not limited to, an offer to become a member of the rewards program, a referral option, an earned compensation option and a reporting option.

The incentive to join the marketing system 10 is the receipt of credit which may, for example, take the form of cash, credit toward purchases with certain merchants, or prizes. Credit may be earned for a variety of reasons such as, for example, making a referral, making a referral that results in the consumer accessing one or more merchant's web sites, or making a referral that results in one or more sales for a merchant. In certain cases, credit may also be earned directly by the user for performing certain tasks or, for example, viewing or listening to advertisements. Where credit is provided in return for referrals, the credit may, for example, be calculated as a percentage of sales made to referred consumers or as a flat fee per referral. Where credit is provided for performing a task, credit may be given, for example, for time spent viewing advertisements. Credit may be remitted to referring members by, for example, providing products and/or services to the member, providing one or more checks to the member periodically, crediting the member's checking account directly, or crediting a card such as a credit card with a dollar amount.

In a three-party system, such as that illustrated in Figure 1, the marketer may also be compensated for operating and administering the system 10 by, for example, being paid a percentage of sales made through the marketing system 10 or as a flat fee per referral or referral contact.

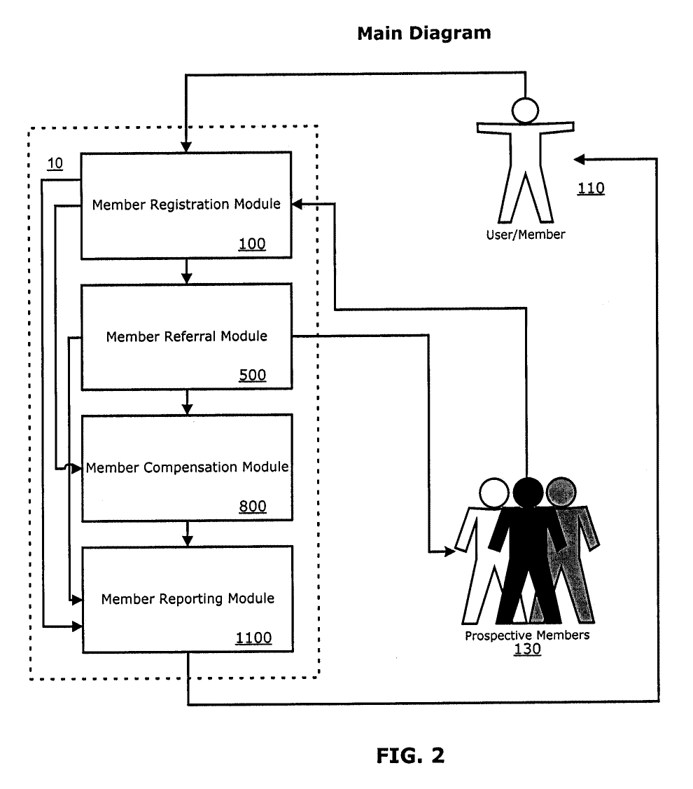

Figure 2 illustrates an embodiment of the present invention wherein the marketing system 10 includes a member registration module 100, a referral module 500, a member compensation module 800, and a member reporting module 1100, each of which modules is described hereinbelow. As shown in Figure 2, a user 110 may access a member registration module 100 by way of a web site that is accessible through the World Wide Web. The member 110 may also refer other prospective members to the web site through the referral module 500, be compensated for participation through the compensation module 800, and view compensation or other credit earned and referral information through the reporting module 1100.

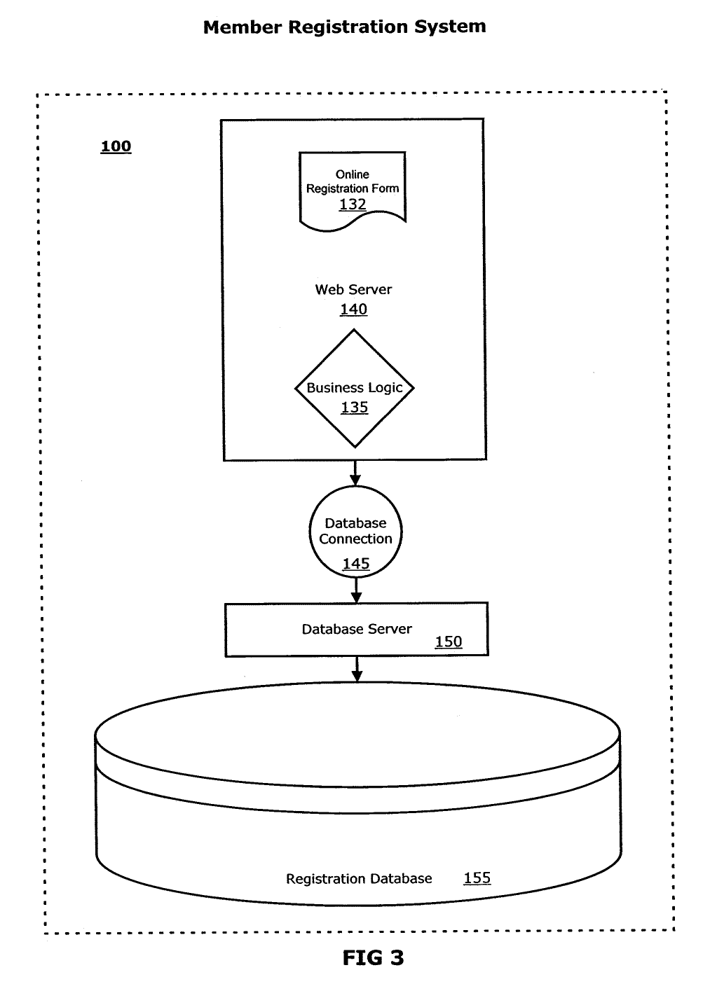

Figure 3 is a diagram illustrating an embodiment of the member registration module 100 of Figure 2. The member registration module 100 may include a web server 140 containing instructions which, when executed, serve an online registration form 132 in, for example, HTML code, to the user 110 and checks information entered into the registration form 132 by the member 110 with a business logic module 135. In operation, a prospective member 110 may input the required information into the online registration form 132 and may submit that information by, for example, clicking a button labeled "submit" on the form 132. The information entered into the online registration form 132 may then be analyzed by the business logic module 135 to determine whether the information meets pre-determined business specifications. If the user's information does meet the business specifications provided by the business logic module 135, then the user's information is transferred to a database server 150 through, for example, a database connection 145. The database server 150 then inserts the information into a registration database 155 that may reside on the database server 150. Once that process is complete, the web site user 110 may be re-classified as a registered member of the aforementioned web site. If the user's information does not meet the business specification provided by the business logic module 135, the user 110 may be returned to the online registration form 132 and asked to re-enter any information that did not meet the business specification. The data may also be saved to another storage device at one or more merchant's computers in a three-party system. The storage devices may be, for example, magnetic memory devices organized in, for example, a database structure.

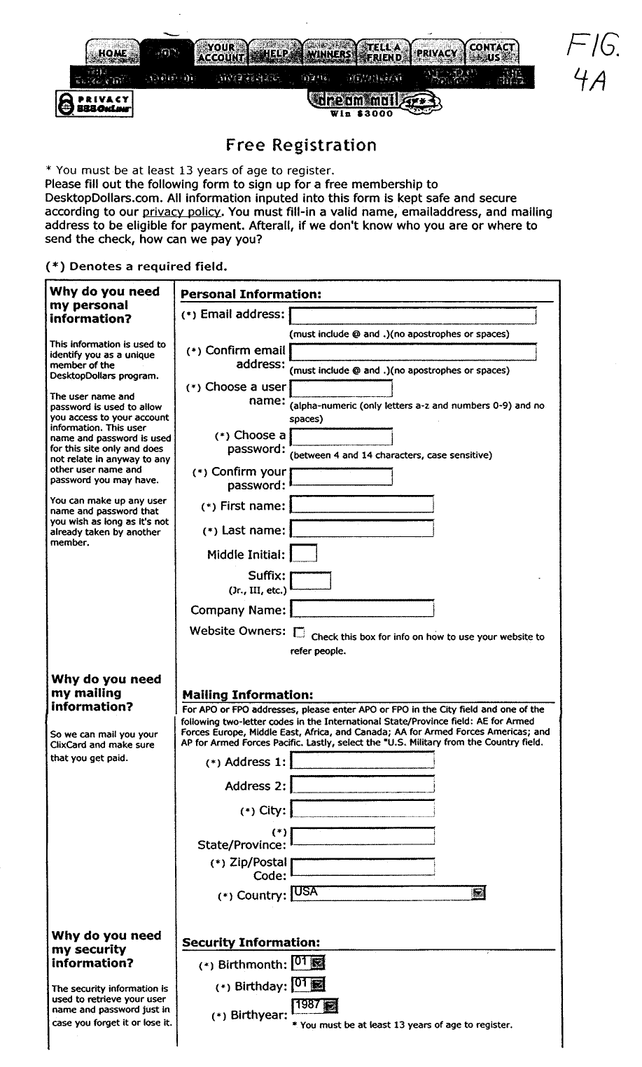

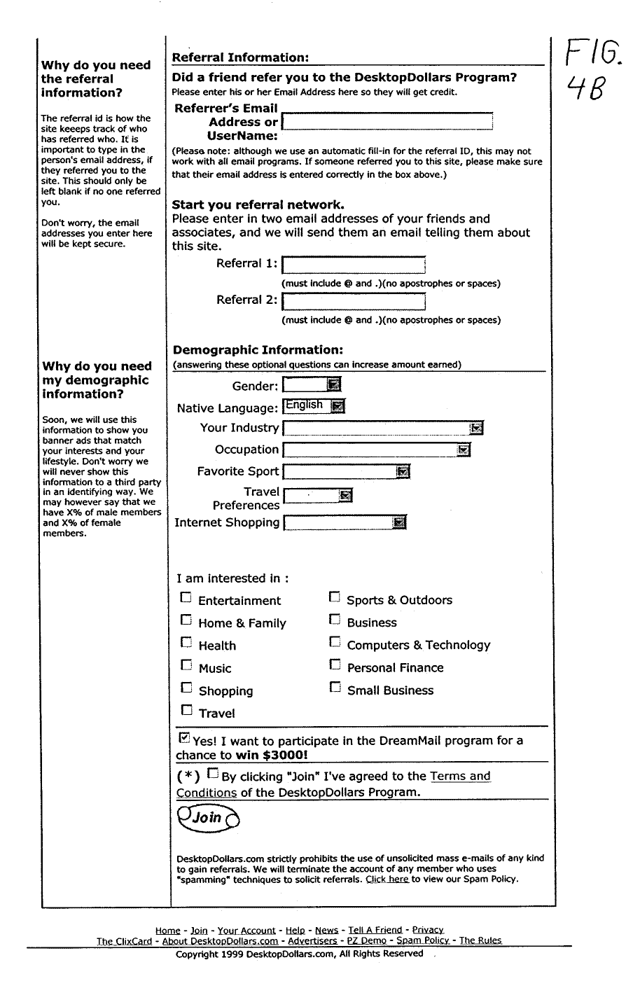

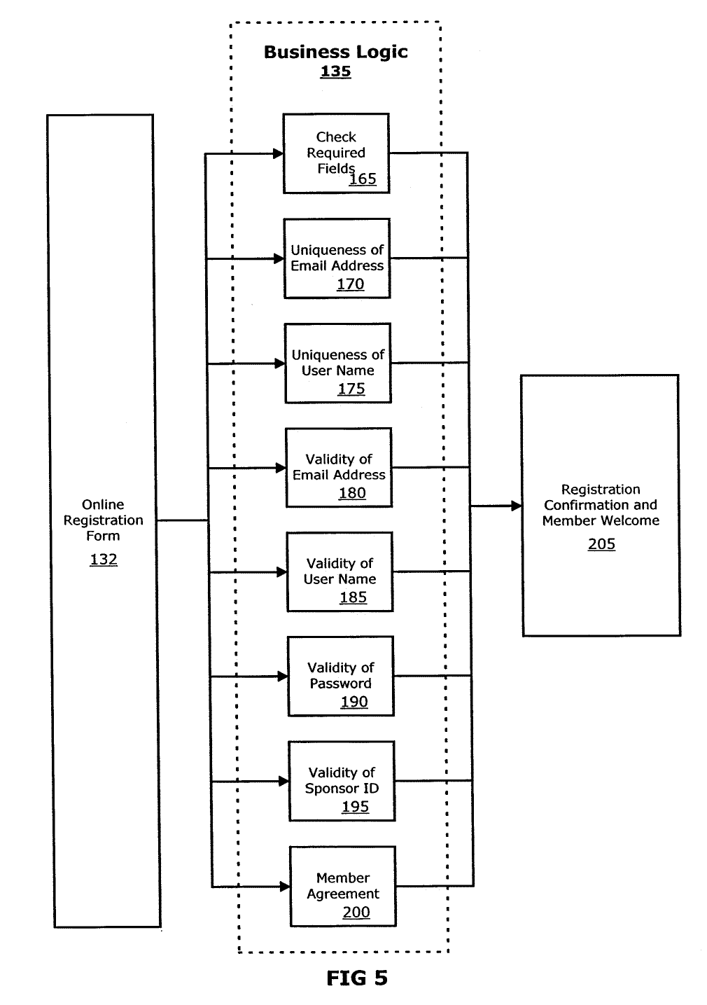

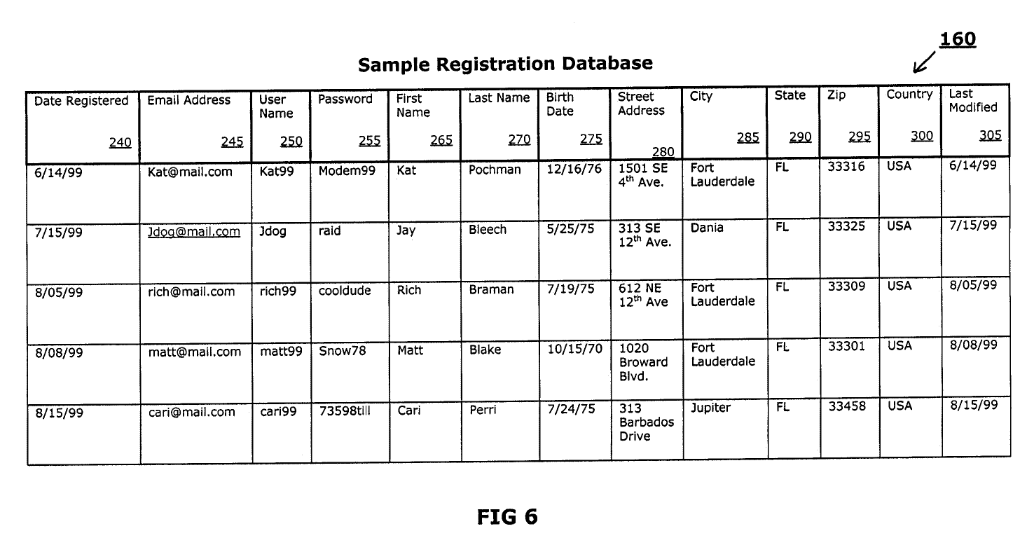

Figures 4A and 4B illustrate an embodiment of a membership registration form 132, and Figure 5 is a diagram illustrating an embodiment of the business logic module 135 of Figure 3. The business logic 135 may analyze the information entered by the user into the online registration form 132 by comparing that information to a business specification. The comparison may, for example, be based on eight different parallel business specifications as illustrated in Figure 5. At step 165, the business logic module 135 may check to ensure that all of the required fields of the online registration form 132 are filled in by the user. Figure 6 illustrates sample fields for information that the user is required to provide in one embodiment of the invention, and which include the member's email address 245, user name 250, password 255, first name 265, last name 270, birth date 275, street address 280, city 285, state 290, zip code 295, and country of residence 300. The date registered 240 and date the record was last modified 305 may be automatically recognized by the system when the member 110 registers and changes account information.

At step 170 of Figure 5, the business logic module 135 system verifies the uniqueness of the email address 245. The email address 245 may be used for a number of purposes including permitting the system provider to contact the member 110 via email and as a unique identifier for the member 110. To verify the uniqueness of the email address 245, the business logic module 135 compares the email address submitted by the user 110 to all of the other email addresses already in the member registration database, to verify that the email address is unique in the system. At step 175, the business logic module 135 verifies the uniqueness of the user name 250 by comparing the user name 250 submitted by the user 110 with all of the other user names already present in the member registration database 155. The user name 250 may, for example, be utilized on a computer of the member 110 screen as the member 110 navigates through the web site to provide a personal touch to the system and to assure the member 110 that he or she is acting on his own account. At step 180, the validity of the email address 245 is determined to ensure that the email address 245 is in the proper email address format (i.e. someone@something .com). At step 185, the validity of the user name 250 is checked against pre-defined parameters to assure that the number of characters and the type of characters are within a permissible range. For example, the business logic module 135 could be pre-defined to state that the user name 250 must be between 4 and 14 characters in length and must be alphanumeric in composition. At step 190, the business logic module 135 verifies the validity of the password 255 by comparing the password to a set of pre-defined business rules. For example, the pre-defined rules could require that the password be between 4 and 14 characters in length and the pre-defined rules may also differentiate between upper and lower case letters. The password may be used by the system 10 to prevent unauthorized access to the member's account. At step 195, the validity of the sponsor identifier is verified by comparing the sponsor identifier against user names in the registration database 155 to ensure that the sponsor identifier matches a user name of a current member of the system. At step 200, it is verified that the user 110 has agreed to a member agreement by, for example, verifying that the member 110 has performed the requested affirmation of the member agreement which may be provided on the online registration form 132.

From the perspective of the user 110, the member registration module 100 may accomplish several functions. First, the member registration module 100 processes the member's information and submits that information to the registration database 155 in the proper format, as described above. Second, the member registration module detects whether the user 110 was referred to the site by another member.

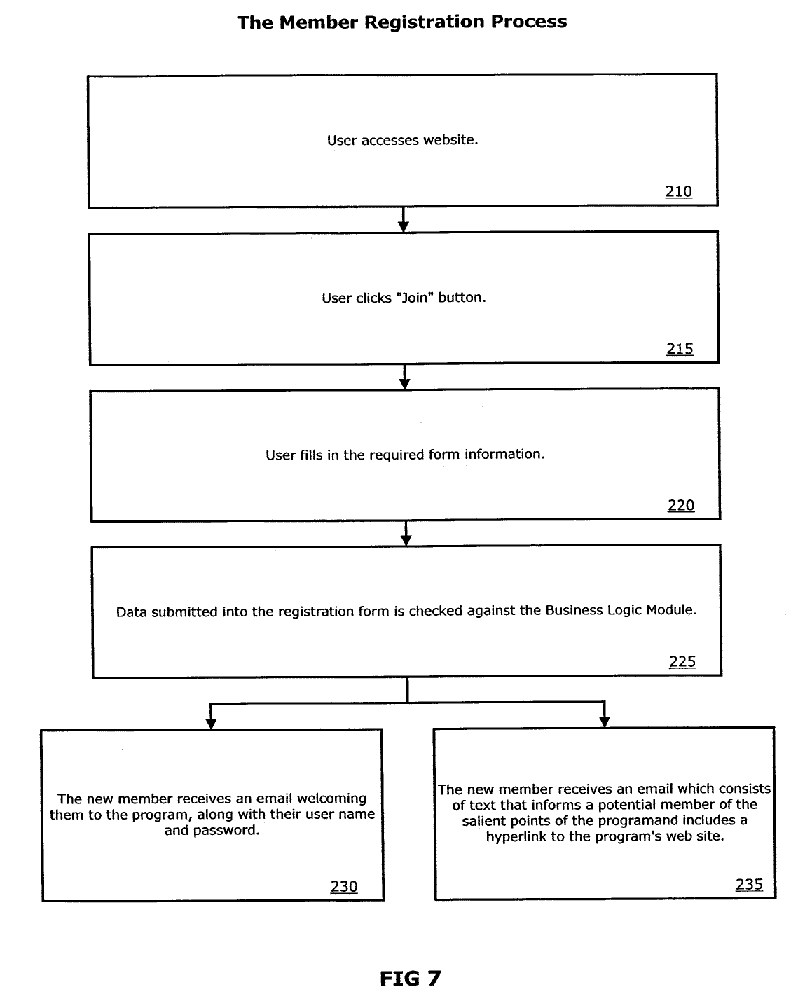

Figure 7 illustrates an embodiment of a flow through the membership registration module 100 of Figure 2. At Step 210, the user 110 may access the web site using, for example, an Internet connection and a web browser. The web site may, for example, use a uniform resource locator (URL) recognition mechanism to detect whether the member 110 has a sponsor identifier, and was, therefore, referred by a member of the site. For example, a user 110 that came to the web site with a sponsor identifier could have a URL such as "http://www.yourwebsite.com/default. asp?id=username." The URL recognition mechanism may then analyze the URL and recognize that the present user was referred by the member whose user name is "username." If, on the other hand, the member 110 came to the web site of the member's own accord and has not come by way of a referral mechanism, the URL utilized could be, for example, "http://www.yourwebsite.com." The URL recognition mechanism may recognize that the present user was not referred by another member because no sponsor identifier is included in that URL. Thus, by automatically including the sponsor identifier in the prospective member's URL when the URL is created, the system may recognize that the prospective member was referred to the web site and also may determine the member that referred the prospective member.

Either of the above URL links will take the user 110 to the home page of the web site. As outlined in Step 215 of Figure 7, the user 110 may click on a button or hyperlink that says, for example, "Join," and the system will take the user to the online registration form 132 when selected. If the user 110 had come to the site with a URL that includes a sponsor identifier, resembling, for example, "http://www.yourwebsite.com/default.asp?id=username," then the field labeled "sponsor identifier" could be automatically filled in by the URL recognition mechanism. However, if the user 110 had come to the site through a URL that does not include a sponsor identifier, resembling, for example, "http://www.yourwebsite.com," then the sponsor identifier could be blank.

Step 220 of Figure 7 describes an embodiment of the invention in which the user 110 fills in the required online registration form 132 information, as well as any non-required information that the user 110 chooses to include on the registration form 132. A member agreement may be included in the registration form 132 or may be linked to the registration form 132 and may describe, for example, conditions of membership. At step 225, the user 110 may check a box that states that the user 110 agrees to a member agreement of the web site, which is provided on the online registration form 132. The user 110 may then, for example, click a "Join" or "Submit" button to submit the user's information to the member registration module 100, which may check the information input using the business logic module 135 at step 225 to determine whether the information is adequate for acceptance or whether the user 110 should be returned to the registration form 132 and notified that an error exists in the entered data.

After a user 110 has been successfully entered and processed through the member registration module 100, the member registration process recognizes that the user 110 is now a member and may send the new member two email messages by way of a membership confirmation module. At step 230 of Figure 7, a first email message, which may be a simple membership confirmation that includes the member's user name, is sent to the member 110. The first email message may furthermore welcome the new member and entice the new member to make purchases by offering, for example, special purchasing opportunities.

At step 235, a second email, which may be termed a "referral gateway" is sent to the member 110. The referral gateway may consist of text that informs a potential member of the salient points of the program and may include a hyperlink to the system web site that includes the new member's sponsor identifier. The sponsor identifier may be embedded into the email via the hyperlink so that if a potential member clicks on it, and then subsequently registers for the program, the referring member will get credit for the referral. The referral gateway provides members an easy way to refer additional members to the program and seamlessly, from the perspective of the member, receive credit for that referral.

Once the member registration process is complete and the information has been submitted through the member registration module 100, the member 110 may have an account with the system provider so that the member 110 may participate in other system features. The new member's information may be stored in the registration database 155 illustrated in Figure 3. As was previously discussed, the information may be stored in a single database or multiple databases. Membership data may be divided into three categories. Figures 6, 8 and 9 illustrate sample member records having required data, sponsor identifier data and non-required data respectively.

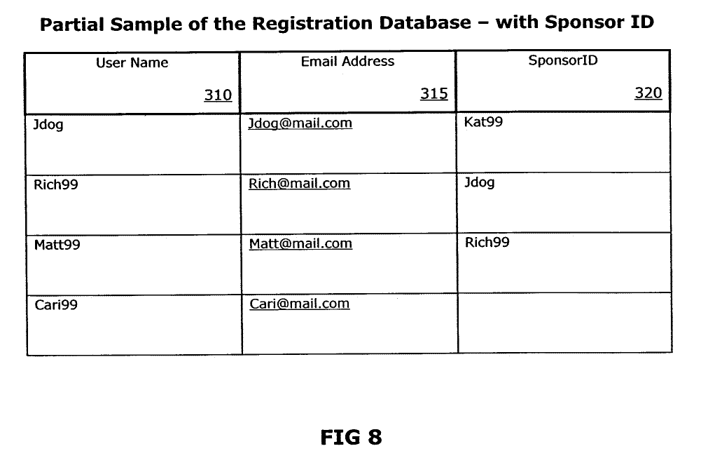

Figure 8 exhibits sample sponsor identifiers for four member records. In any given member record, the sponsor identifier fields may be filled in if the member 110 became a member through a referral by another member, or it may be blank if the member did not became a member through a referral by another member. If the sponsor identifier field or fields are included in a record, the fields should match one user name in the registration database 155. As is shown in Figure 8, the sponsor identifier may be associated in the database 155 with other member information including the referred member's email address 315 and user name 310. In that way, a referring member may be correlated to one or more referred members.

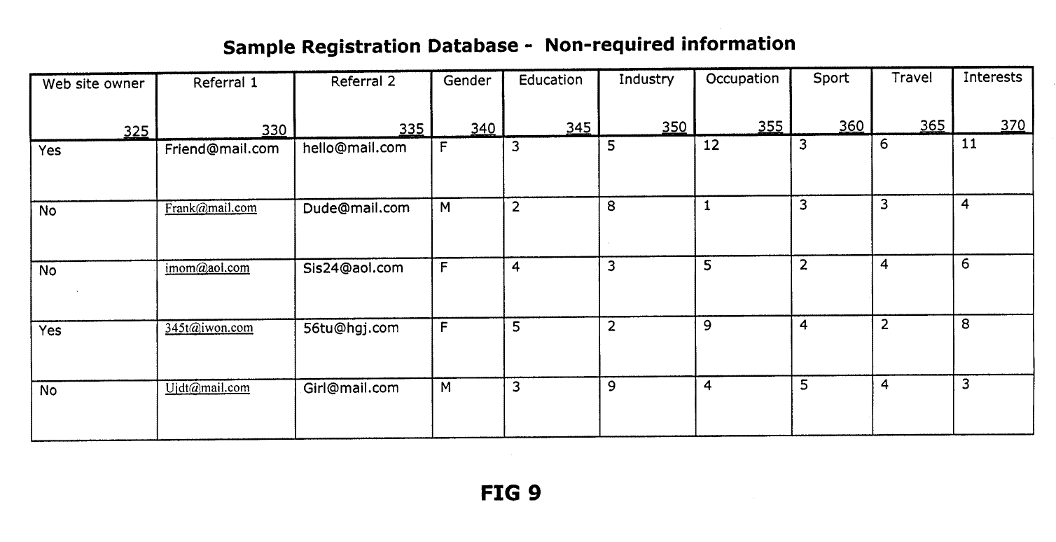

Figure 9 exhibits a partial sample of an embodiment of the registration database 155, including only the non-required information. Personal information may be provided including, for example, whether the application is a web site owner 325, referral 1 330, referral 2 335, gender 340, education 345, industry 350, occupation 355, sport interest 360, travel interest 365, and other interests 370 as illustrated in Figure 9. Any or all of the non-required fields could potentially be blank if the member chooses not to provide any of the non-required registration information. Either "yes" or "no" may be entered in the web site owner field 325. The referral 1 field 330 and the Referral 2 field 335 may be either blank or contain email addresses for other potential members. The gender field 340 may contain, for example, either an F or an M as a value, representing "female" and "male" respectively. The remainder of the fields, education 345, industry 350, occupation 355, sport 360, travel 365, and interests 370, may take on numeric values that relate, for example, to activities in which the member is interested. For example, each field may have several options that the member can select from, and each option for each field may have a numeric value associated with it. So, for example, if the option "baseball" is assigned the numeric value of "2" for the field sport 360, and if the user selects "baseball" from the list of options for sport, the value "2" will be inserted into the sport 360 column in the record for that particular user. The personal information may be utilized, for example, to determine what target audience or audiences the member falls into to personalize special offers provided to that member.

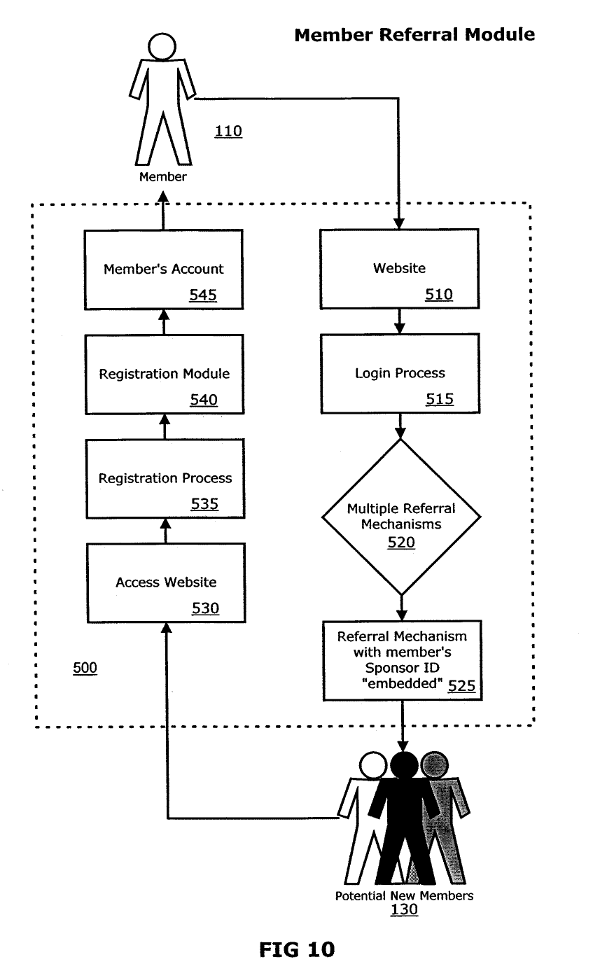

Figure 10 is a flow diagram of an embodiment of a flow through the member referral module 500 of Figure 2. Once the user 110 becomes a member 110, the member 110 may refer others to the site through the use of the member referral module 500. As shown in Figure 10, the member 110 may return to the web site at step 510 and then log in with the member's user name 250 and password 255, which comprise a "login process" shown at step 515. After the member 110 logs in, the member 110 may select from multiple referral mechanisms at step 520 of Figure 10. Each one of the referral mechanisms 520 may be embedded with the member's sponsor identifier at step 525 automatically by retrieving the member's sponsor identifier from the member registration database 160. Once it has been prepared, the referral mechanism is forwarded to one or more potential new members 130. A potential new member 130 may then access the web site at step 530 by, for example, selecting a link from the referral mechanism. At step 535, the potential new member 130 may register and at step 540, the registration module 100 may check the registration data and accept the new member 130. At step 545, the new member 130 is provided an account through which the original member 110 may receive credit for any participation of the new member 130.

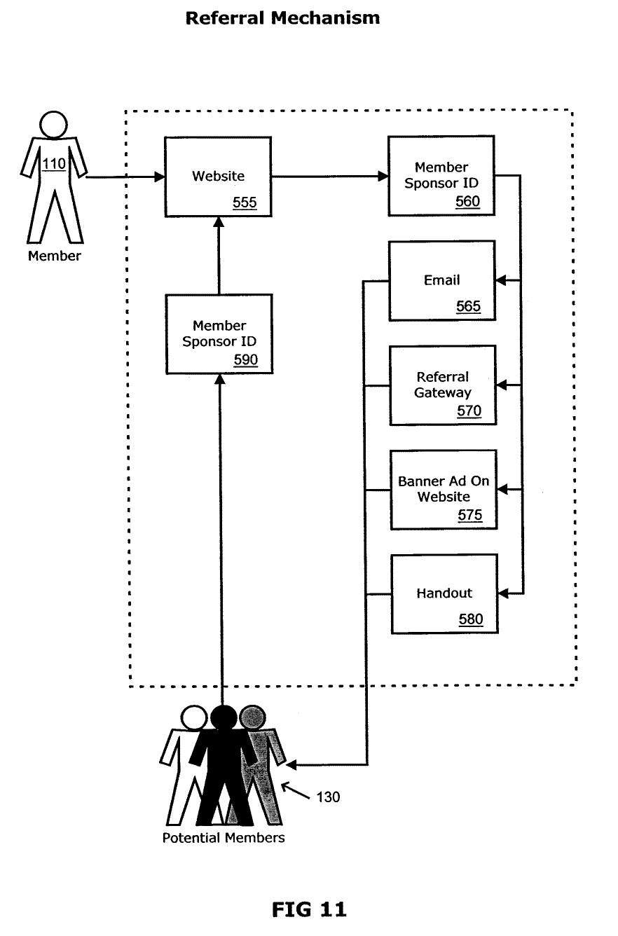

Figure 11 is a flow diagram illustrating four possible referral mechanisms which include email, a referral gateway, a banner, and a handout. Email and the referral gateway are relatively quick and easy to use. As illustrated in Figure 11, the member 110 may access the web site at step 555, access his sponsor identifier at step 560 and attach that sponsor identifier to an email at step 565, a referral gateway at step 570, a banner ad on a web site at step 575 and/or a handout at step 580. The referral mechanism is then forwarded to one or more potential members 130. At step 590, the sponsor identifier of the referring member 110 is communicated to the web site when the potential member 130 becomes a member so that the referring member 110 receives credit for new member 130 activity.

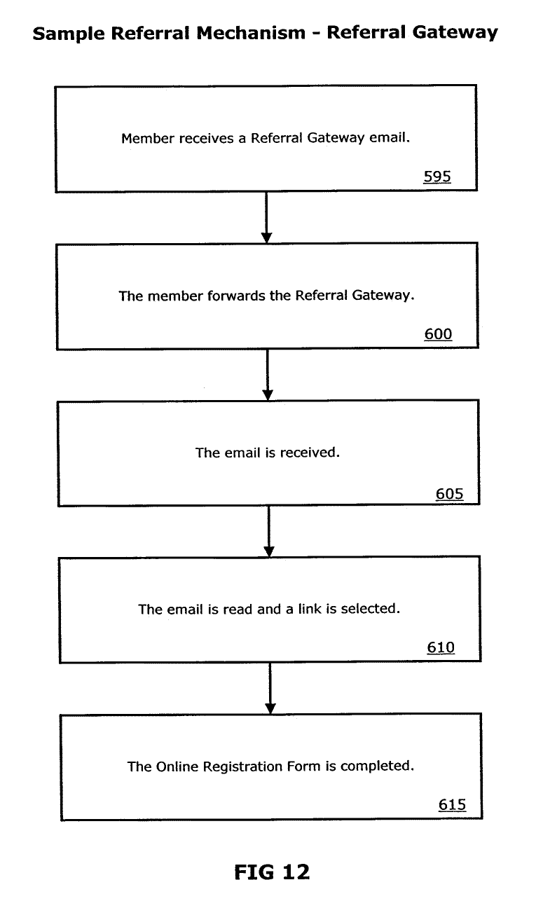

Figure 12 illustrates an example of a process that may be utilized in connection with the referral gateway. At step 595, the member 110 receives the referral gateway in an email box after they have requested it be sent to them from the site. The referral gateway may include text that describes the benefits of the program and contains a link to the program's web site that has the member's sponsor identifier "embedded" in it. For example, the referral gateway may include standard but modifiable language that is automatically produced by the system for forwarding to the person being referred. The modifiable message may read, for example, "Thought you would enjoy this site. It looks like a great opportunity. It costs nothing to register and they'll even pay you a percentage for referring your friends. Check it out." At step 600, the member 110 forwards the referral gateway to a potential member 130. The subject line of the email may state "Message from "Member's Name"" to inform a known potential member 130 that the email is not spam, but, rather, is a personal message from the member 110. At step 605, the person being referred 130 receives the email. The email may explain the benefits of membership to both the person being referred 130 and the referring member 110. At step 610, the email recipient is given an opportunity to become a member by, for example, clicking on a link that takes the email recipient 130 to the web site. The email recipient 130 may then access the online registration form 132 to become a member. The sponsor identifier box may be automatically filled in where the web site is capable of recognizing and capturing the sponsor identifier of the referring member 110 which is carried to the web site link from referral email. Thus, at step 615, when the email recipient 130 becomes a member, the original member 110 receives credit for referral by way of the sponsor identifier.

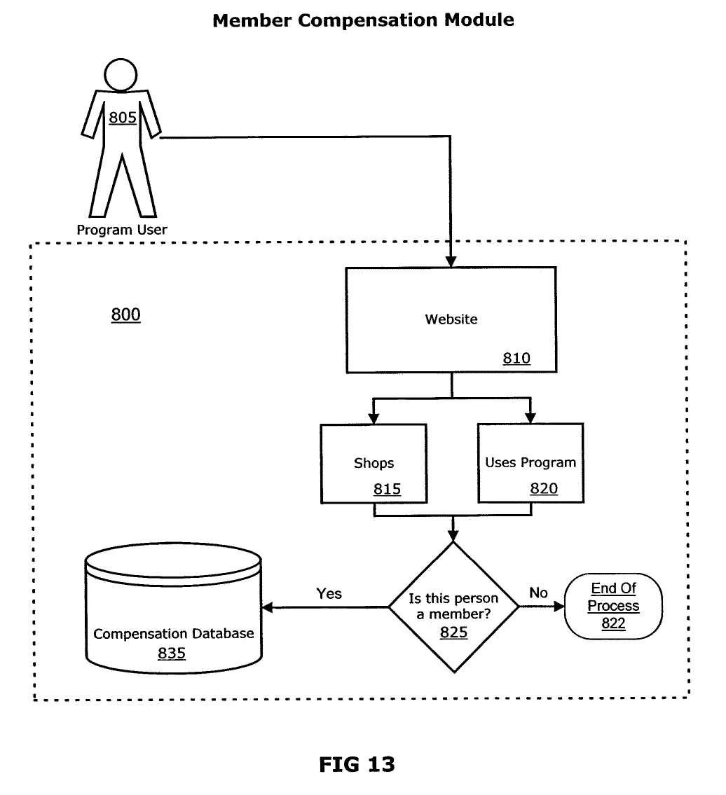

Figure 13 depicts a block diagram of an embodiment of the member compensation module 800 of Figure 2 on a single-level basis. The member compensation module 800 of Figure 13 is utilized to track the compensation credited to a member 110 for the member's 110 and/or the member's referral's 130 participation in the program. When a program user 805 accesses the web site at step 810 and participates in the program, which can take the form of shopping or using a service at step 815, or participating in a program at step 820, the member compensation module 800 determines whether the program user 805 is a member. During the registration process 535, the sponsor identifier is inserted into the registration form from the referral mechanism so that the referring member 110 receives credit for the new member's 130 shopping, use of service, or program participation at step 825, by including the referring member's 110 sponsor identifier 320 in the new member's 130 record in the registration database 155, as is illustrated in Figure 8. If the program user 805 is not a member and was not referred by a member, then no compensation-related action is performed at step 822. If the program user 805 is a member or was referred by a member, then credit is provided for the appropriate referring member or using member at step 825, and is saved in a compensation database 835.

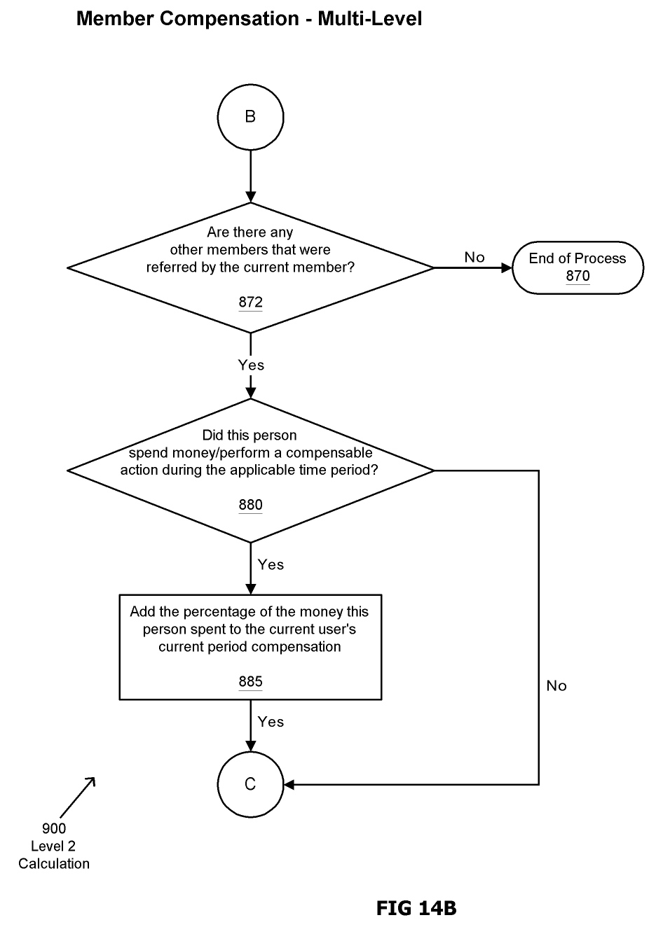

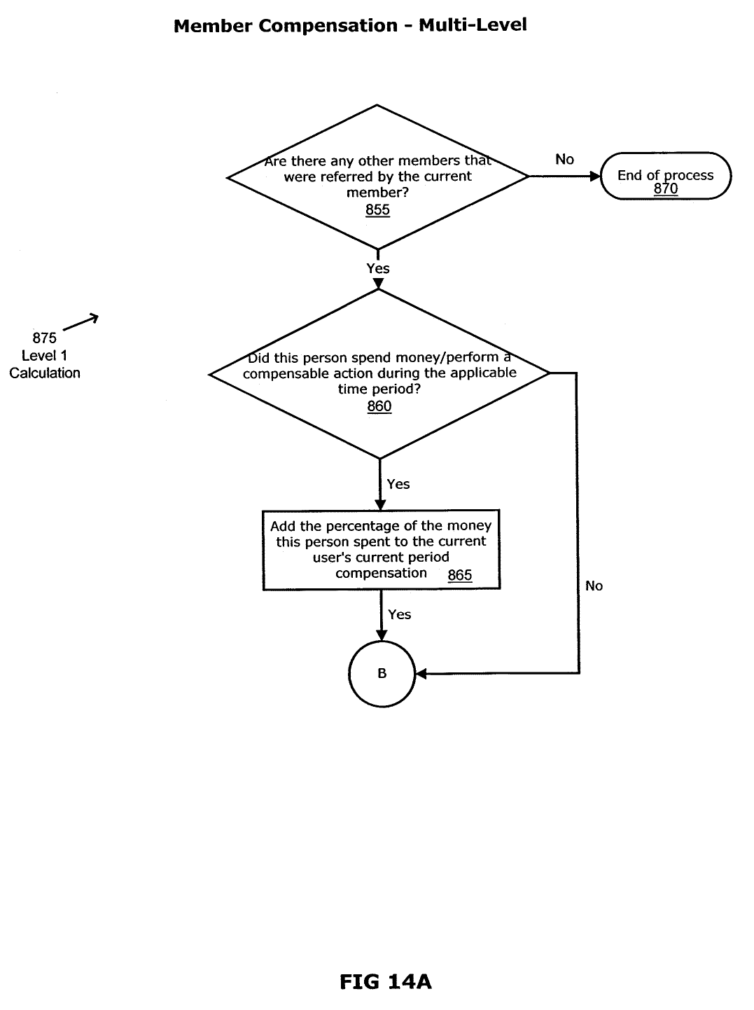

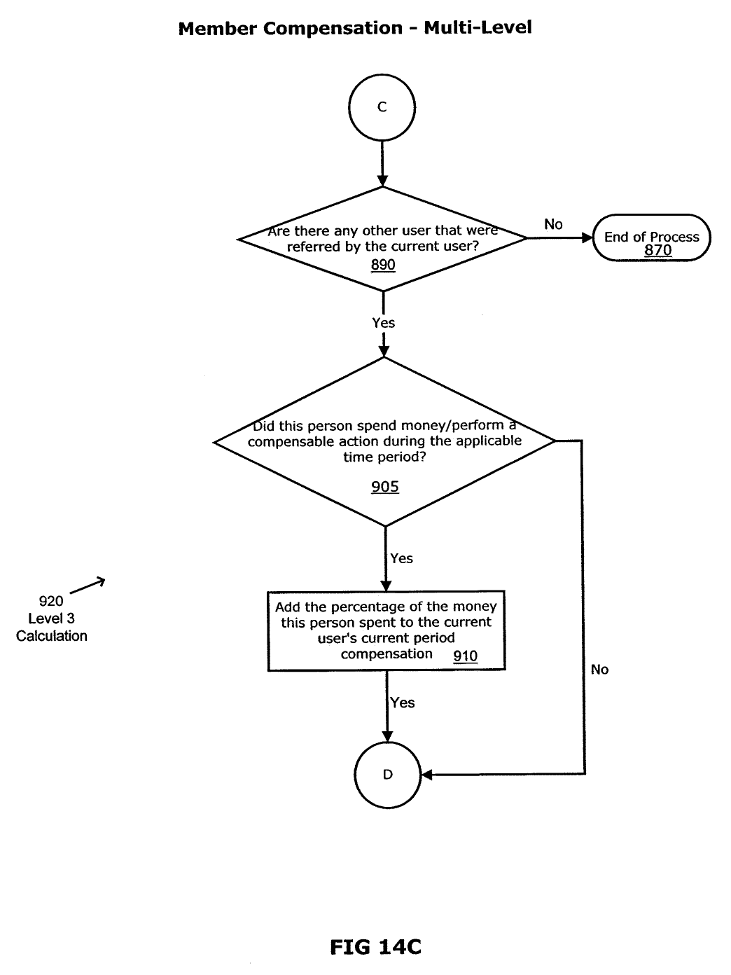

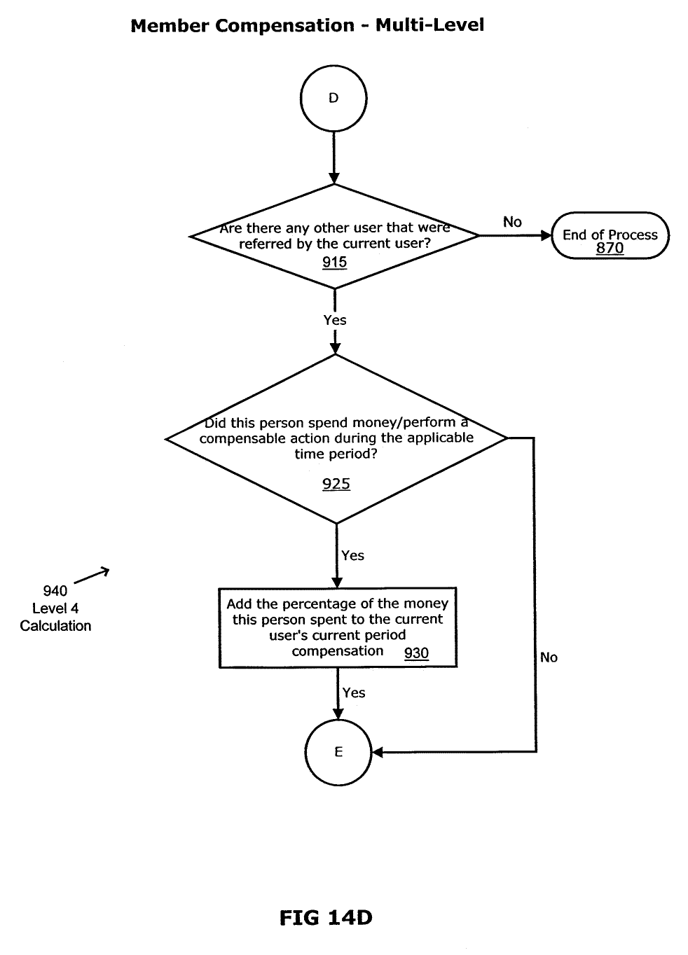

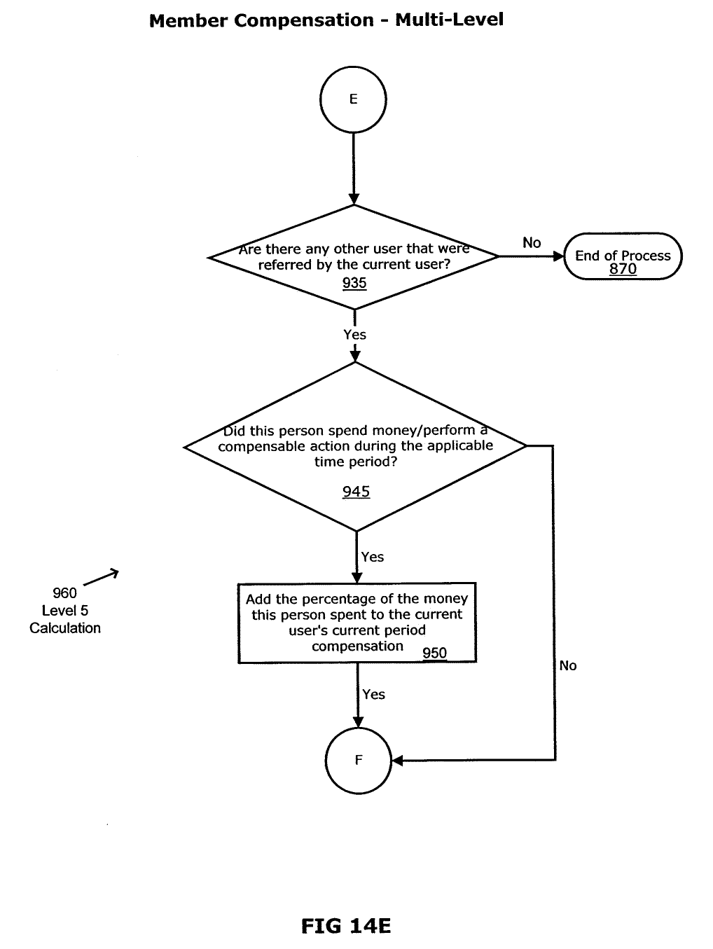

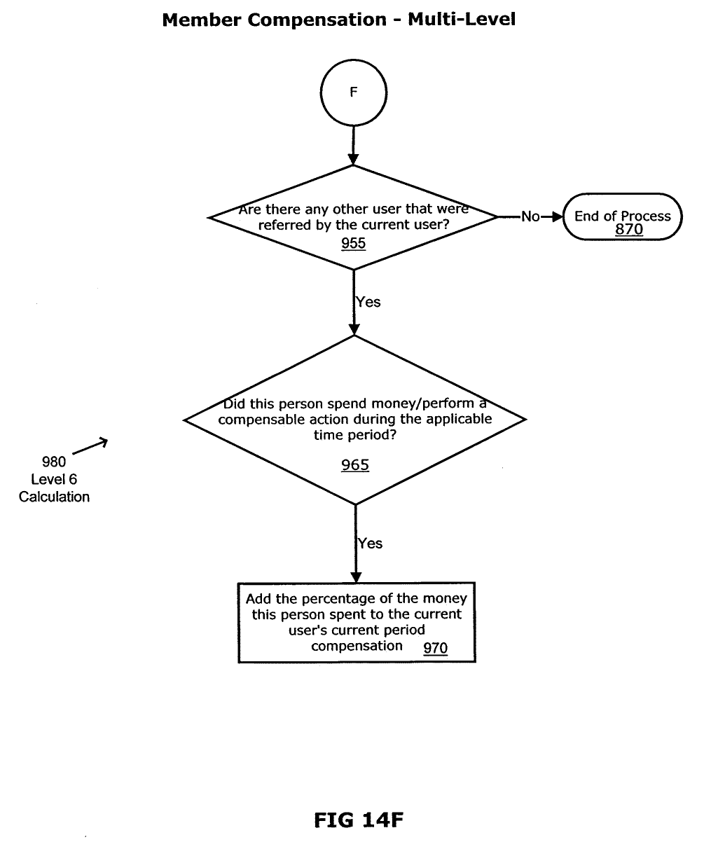

Figures 14A 14F depict one embodiment of a flow through the member compensation module 800 on a multi-level basis. Figure 14A depicts a Level 1 member compensation calculation 875. At step 855, the system analyzes the registration database 155 to determine whether there are any other members 130 that were referred by the current member 110. If the analysis determines that there are not, then the process is terminated at step 870. If the analysis determines that there are additional members 130 that were referred by the current member 110, then the module 800 accesses the compensation database to see if those additional members discovered in step 855, which may be referred to as level 1 referrals, have earned any compensation for the referring member 110 during the applicable time period at step 860. If that analysis determines that those additional members have earnings, then those earnings are added to the current user's current period compensation in the compensation database 835 at step 865. The process then proceeds to a Level 2 calculation 900 illustrated in Figure 14B.

Figure 14B is a flow chart depicting the Level 2 member compensation calculation 900. At step 872, the module analyzes the registration database 155 to determine whether there are any other members 130 that were referred by the current member's level 1 referrals 110. If the analysis determines that there are not, then the process is complete at step 870. If the analysis determines that there are additional members 130 that were referred by the current member's level 1 referrals, which may be referred to as level 2 members, then the system 10 accesses the compensation database 835 to determine whether those level 2 members, discovered at step 872, have earned any compensation for the referring member 110 during the applicable time period at step 880. If that analysis determines that those level 2 members have earnings, then those earnings are added to the current user's current period compensation in the compensation database at step 885. The process then proceeds to a Level 3 calculation 920 illustrated in Figure 14C.

Figure 14C is a flow chart depicting the Level 3 member compensation calculation 920. At step 890, the module 800 analyzes the registration database 155 to see if there are any other members 130 that were referred by the current member's level 2 referrals. Those members that were referred by the current member's level 2 referrals may be referred to as level 3 referrals. If the analysis determines that there are not any level 3 members, the process is terminated at step 870. If the analysis determines that there are level 3 members 130, then the module 800 accesses the compensation database 835 to determine whether these level 3 members 130, discovered at step 890, have earned any compensation for the referring member 110 during the applicable time period at step 905. If that analysis determines that those level 3 members have earnings, then those earnings are added to the current user's current period compensation in the compensation database at step 910. The process then proceeds to a Level 4 calculation 940 illustrated in Figure 14D.

Figure 14D is a flow chart depicting the Level 4 member compensation calculation 940. At step 915, the system analyzes the registration database 155 to determine whether there are any other members 130 that were referred by the current member's level 3 referrals. If the analysis determines that there are not, then the process is terminated at step 870. If the analysis determines that there are level 3 members 130 that were referred by the current member level 3 referrals, then the module 800 accesses the compensation database 835 to determine whether those additional members 130, discovered at step 915, which may be referred to as level 4 referrals, have earned any compensation for the referring member 110 during the applicable time period at step 925. If that analysis determines that those additional members have earnings, then those earnings are added to the current user's current period compensation in the compensation database 835 at step 930. The process then proceeds to a Level 5 calculation 960 illustrated in Figure 14E.

Figure 14E is a flow chart depicting the Level 5 member compensation calculation 960. At step 935, the module 800 analyzes the registration database 155 to determine whether there are any other members 130 that were referred by the current member's level 4 referrals, and which may be referred to as level 5 referrals. If the analysis determines that there are not, then the process is terminated at step 870. If the analysis determines that there are level 5 members 130, then the module 800 accesses the compensation database to determine whether those level 5 members, discovered at step 935, have earned any compensation for the referring member 110 during the applicable time period at step 945. If that analysis determines that those level 5 members have earnings, then those earnings are added to the current user's current period compensation in the compensation database 835 at step 950. The process then proceeds to a Level 6 calculation 980 illustrated in Figure 14F.

Figure 14F is a flow chart depicting the Level 6 member compensation calculation 980. At step 955, the module 800 analyzes the registration database 155 to determine whether there are any other members 130 that were referred by the current member's level 5 referrals. If the analysis determines that there are not, then the process is terminated at step 870. If the analysis determines that there are additional members 130 that were referred by the current member's level 5 members, which may be referred to as level 6 referrals, then the module 800 accesses the compensation database 835 to determine whether those level 6 members, discovered in step 955, have earned any compensation for the referring member 110 during the applicable time period at step 965. If that analysis determines that those level 6 members have earnings, then those earnings are added to the current user's current period compensation in the compensation database at step 970. The embodiment of the invention described herein illustrates a six-level system. It will be recognized, however, that the multi-level member compensation scheme presented herein may provide compensation to a member for any desired number of levels. It will also be recognized that compensation may be calculated in other ways and that the search order may be altered.

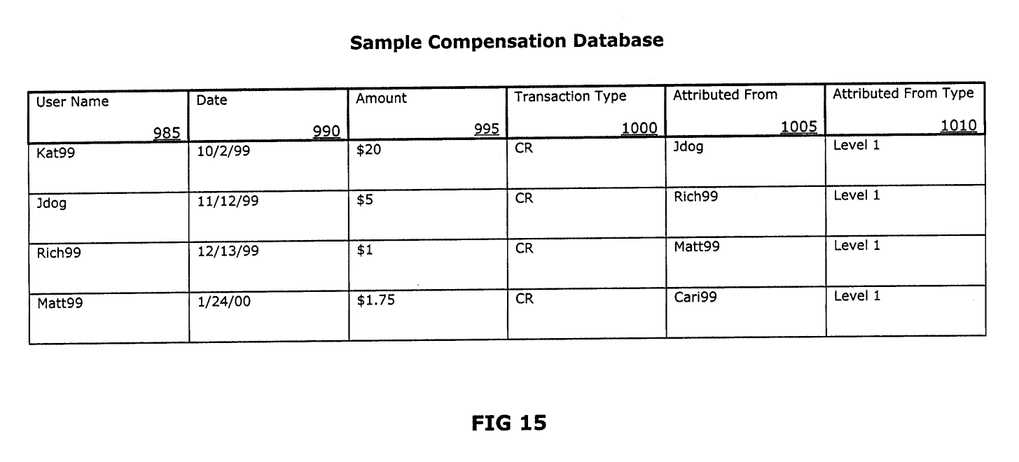

Figure 15 illustrates sample compensation database entries in the computer database 835. During the process described above, records may be created in the member compensation database 835 when a member 110 receives credit for program participation. The sample compensation database illustrated in Figure 13 shows records that may be created in the member compensation database 835. There are eight pertinent fields in the member compensation database 835 shown in the embodiment illustrated in Figure 15. The user name 985 identifies the member that the particular record belongs to. The date field 990 identifies the date that the particular record was created. The amount field 995 indicates the amount earned by the member through a particular transaction. The transaction type 1000 is either a debit (DR), which represents a payment out to the member 110 or a credit (CR) which represents amounts that are owed to the member. The attributed from field 1005 represents the user name of the member 110 that the amount was attributed from. If the amount in the record is for a credit as a result of the member's own actions, then the value will be the member's own user name. If, for example, the amount in the record is for a credit for the actions of a Level 1 referral, then that particular referral user name will be inserted into that field. The attributed from type 1010 identifies which level the amount is attributed from. For example, if the amount is attributed to the member's own action then "Level 0" will be inserted. However, if the amount is attributed to the action of the member's Level 1 referral, then "Level 1" will be inserted.

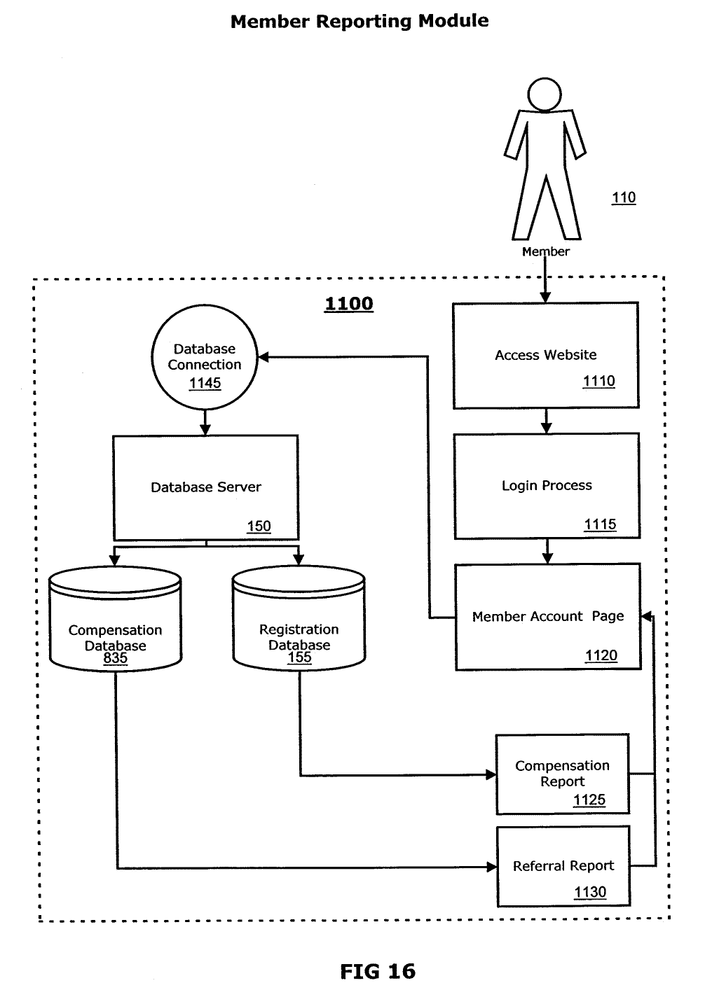

Figure 16 illustrates an embodiment of a flow through the member reporting module 1100. The member reporting module 1100 provides a record of all referrals made by a member 110 and may also provide a record of the amount of credit that the referring member 110 has accumulated for site access and purchases made by those who the member 110 referred. The member reporting module 1100 may also create a member reporting screen that provides those records to the referring member.

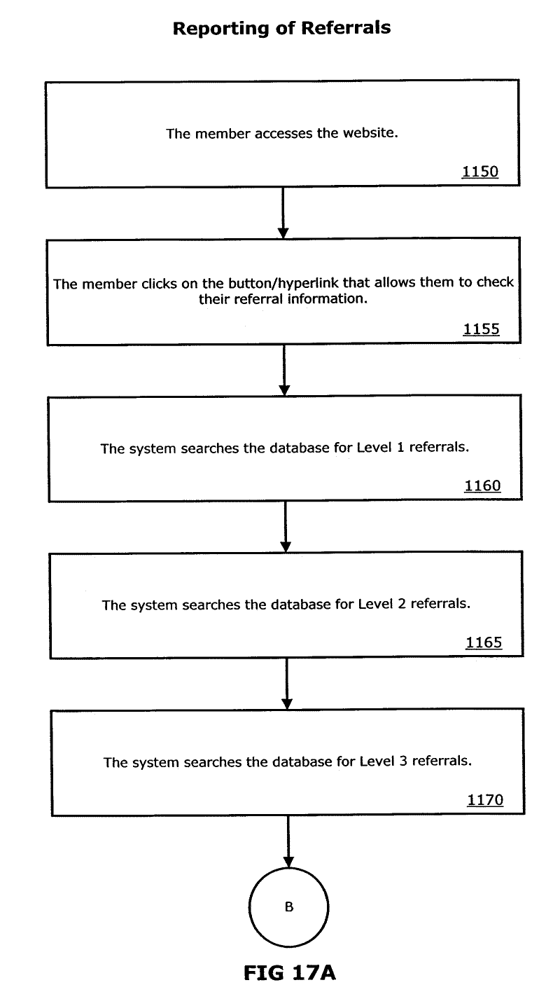

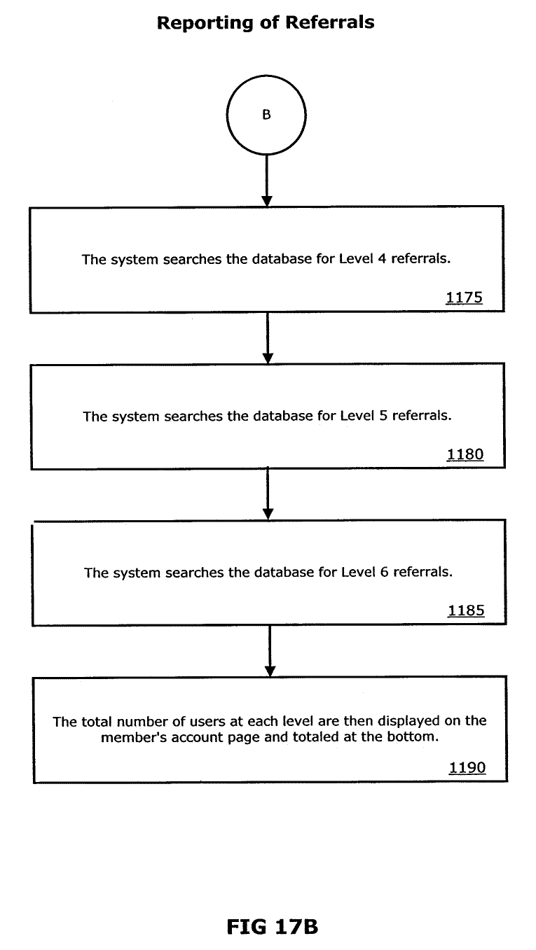

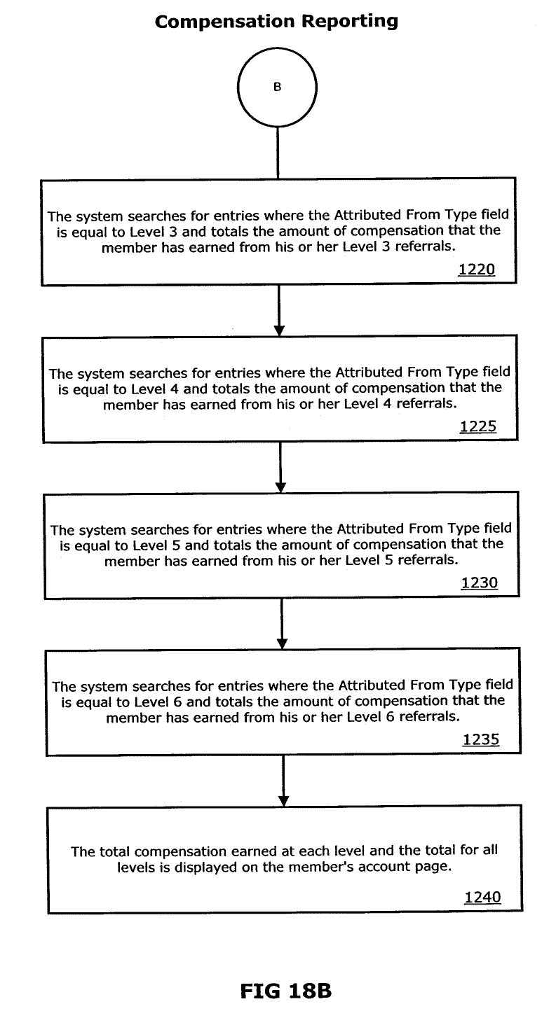

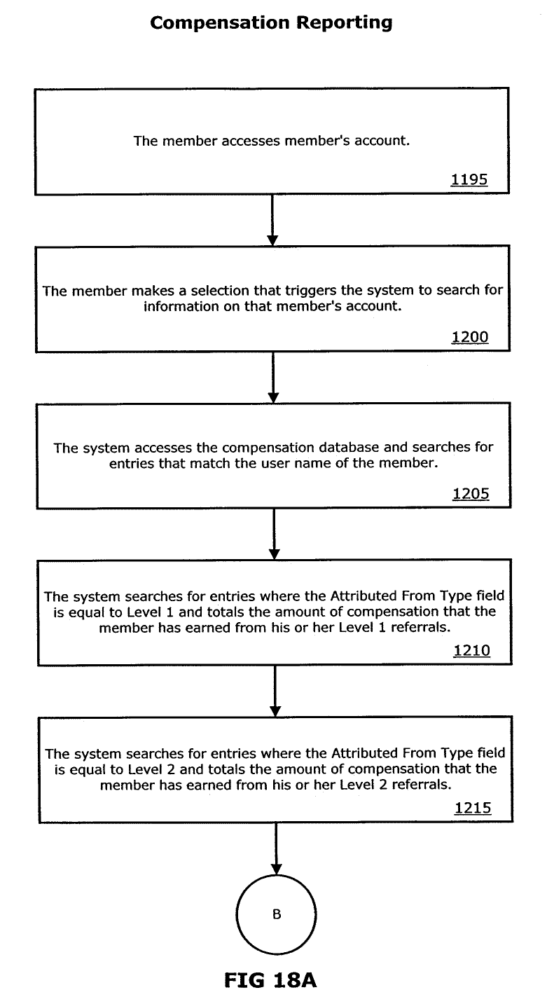

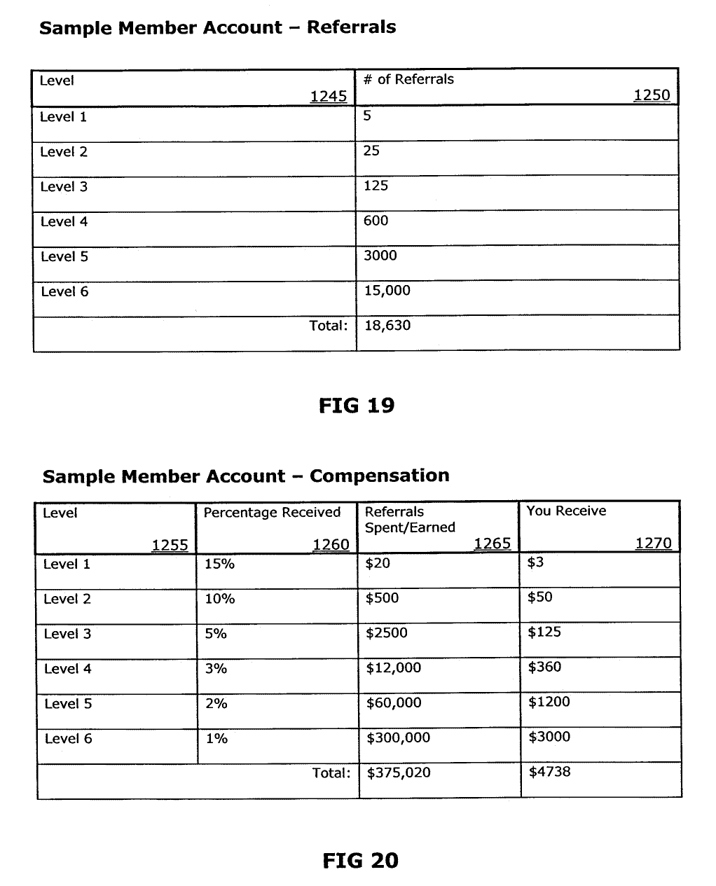

As shown in Figure 16, the member reporting module 1100 extracts data from the member registration database 155 and the member compensation database 835 and displays that information on the member's compensation report 1125 and the member's referral report 1130 on the member's account page 1120. At step 1110, the member 110 accesses the web site. At step 1115, the member may login by, for example, typing the member's user name and password and clicking submit. That action takes the member 110 to the member's account page 1120 on the web site. The database server 1150, the registration database 155 and the compensation database 1136 may be accessed through a database connection 145. The records of the member that is currently logged in may be accessed in the manner described in connection with Figures 17 A-B below in the member registration database 155 and may be displayed on a referral report 1130. The records of the member may also be accessed in the manner described in Figures 18 A-B in the member compensation database 1136 and displayed on the compensation report 1125. A sample format of the referral report is exhibited in Figure 19. Figure 19 is a sample member accounting of referrals that shows the member the number of referrals 1250 that the member has on each level. A sample format of a member accounting report for compensation is also exhibited in Figure 20. The compensation report may show the member 110 the percentage of purchases made by referred members 1260 earned on each level 1255, the amount that each level 1260 of referrals has spent and/or earned 1265, and the amount of the compensation 1270 that the member is to receive for each level 1255.

Figures 17A and 17B show an embodiment of a process of reporting a member's referrals to the member's account. At step 1150, the current member 110 accesses a processor at the web site using an Internet connection and a web browser. The current member 110 may click on a button labeled "Your Account," which takes the member 110 to the login screen. At the login screen, the current member 110 may type his user name and password to access the member's account and then click on a button that allows the member 110 to check his referral information. That triggers the reporting module 1100, illustrated in Figure 2, to access the registration database 155 and begin a query for information on that particular member's account at step 1155. At step 1160, a search of the database 155 is performed to determine the number of members 130 whose sponsor identifier is equal to the user name of the member 110 whose account is being accessed. That number is the number of Level 1 referrals for that particular account. At step 1165, a search of the database 155 is performed to determine the number of members 130 whose sponsor identifier is equal to the user names of every member 130 that is in Level 1 of the current member's account. That number is the number of Level 2 referrals for that particular account. At step 1170, a search of the database 155 is performed to determine the number of members 130 whose sponsor identifier is equal to the user names of every member 130 that is in Level 2 of the current member's account. That number is the number of Level 3 referrals for the particular account that is being accessed. At step 1175 of Figure 17B, a search of the database 155 for the number of members 130 whose sponsor identifier is equal to the user names of every member 130 that is in Level 3 of the current member's account is performed. That number is the number of Level 4 referrals for the particular account that is being accessed. At step 1180, a search of the database 155 for the number of members 130 whose sponsor identifier is equal to the user names of every member 130 that is in Level 4 of the current member's account is performed. That number is the number of Level 5 referrals for the particular account that is being accessed 1180. Then, the reporting module 1100 searches the database 155 for the number of members 130 whose sponsor identifier is equal to the user names of every member that is in Level 5 of the member's account is performed. That number is the number of Level 6 referrals for the particular account that is being accessed. The totals for each level are then displayed on the member's account page at step 1190.

Figures 18A and 18B show a process of reporting a member's compensation to the member's account. The member 110 may access the web site using an Internet connection and a web browser. At step 1195, the member 110 may click on the button labeled "Your Account," which takes the member 110 to the login screen where the member 110 may enter his user name and password and gain access to the member's account. The member 110 may then click a button that allows him to check his compensation information. That triggers the module 1100 to access the compensation database 1136 and begin a query for information on that particular member's account. At step 1205, the system accesses the compensation database and searches for any entries that match the user name of the member 110. At step 1210 the system searches those entries for where the "Attributed From Type" field is equal to "Level 1." Those amounts are then added together to come up with the total for this particular member's Level 1 compensation. At step 1215, the system then searches those entries for where the "Attributed From Type" field is equal to "Level 2." Those amounts are then added together to come up with the total for this particular member's Level 2 compensation at step 1215. The system then searches those entries for where the "Attributed From Type" field is equal to "Level 3" at step 1220 as shown on Figure 18B. Those amounts are then added together to arrive at the total for this particular member's Level 3 compensation. At step 1225, the system searches those entries for where the "Attributed From Type" field is equal to "Level 4." Those amounts are then added together to come up with the total for this particular member's Level 4 compensation. At step 1230, the system searches those entries for where the "Attributed From Type" field is equal to "Level 5." Those amounts are then added together to come up with the total for this particular member's Level 5 compensation. At step 1235, the system searches those entries for where the "Attributed From Type" field is equal to "Level 6." Those amounts are then added together to come up with the total for this particular member's Level 6 compensation. The totals for each level are then displayed on the member's account page at step 1240.

Thus, from the foregoing discussion, it is apparent that the present marketing system solves many of the problems encountered by prior advertising methods. The marketing system of the present invention effectively produces traffic at the participating merchant's web site, and may be devised to provide compensation only when the traffic, sales, or other desired activity has actual occurred. The present marketing system furthermore provides a method of providing a marketing opportunity for third party merchants with minimal effort required on the part of the third party merchant.

Those of ordinary skill in the art will, of course, appreciate that various changes in the details, arrangement and choice of equipment and software operation which have been herein described and illustrated in order to explain the nature of the invention may be made by the skilled artisan within the principle and scope of the invention as expressed in the appended claims.

Claims

What is claimed is:
1. A computer-assisted compensation method, comprising:
sending a message from a first party to a second party, wherein the message includes a link and the link has a sponsor identifier;
selecting, by the second party, the link;
correlating the sponsor identifier of the first party with the second party; and
providing credit to the first party.

2. The method of claim 1, wherein providing credit includes providing credit for referring the second party.

3. The method of claim 1, wherein providing credit includes providing credit for an activity of the second party

4. The method of claim 3, wherein providing credit includes providing credit the second party purchasing goods or services.

5. The method of claim 3, wherein said providing credit includes providing credit for advertisements that the second party views.

6. The method of claim 1, wherein the first party is a member of a web site based organization and the second party is a prospective member of the web site based organization.

7. The method of claim 6, further comprising making the prospective member a new member.

8. The method of claim 1, further comprising retrieving a standard message prior to sending the message.

9. The method of claim 1, wherein sending a message includes sending an email.

10. The method of claim 9, wherein the email includes a URL that provides access to a web site and includes the sponsor identifier.

11. The method of claim 1, wherein correlating includes storing the sponsor identifier in a database.

12. A compensation system, comprising:
a processor; and
a memory device in communication with said processor, the memory device having data and instructions stored thereon which, when executed by said processor, cause said processor to:
send a message to a first party for forwarding to a second party, wherein the message includes a link and the link has a sponsor identifier;
receive an inquiry from the second party, wherein said inquiry is initiated by the second party selecting the link;
correlate the sponsor identifier of the first party with an activity of the second party; and
provide credit to the first party for the activity of the second party.

13. A computer readable medium having instructions stored thereon which, when executed by a processor, cause said processor to:
send a message to a first party for forwarding to a second party, wherein the message includes a link to said processor and the link has a sponsor identifier;
receive an inquiry from the second party, wherein the inquiry is initiated by the second party selecting the link; correlate the sponsor identifier of the first party with an activity of the second party; and
provide credit to the first party for the activity of the second party.

14. An apparatus, comprising:
means for sending a message from a first party to a second party, wherein the message includes a link and the link has a sponsor identifier;
means for selecting, by the second party, the link;
means for correlating the sponsor identifier of the first party with the second party; and
means for providing credit to the first party for an activity of the second party.

15. A computer-assisted marketing method, comprising:
identifying a referrer;
correlating a referred consumer and the referrer that referred the consumer;
receiving referred consumer purchase information;
calculating compensation due the referrer for referred consumer activity;
transferring consumer activity-related data to a merchant storage device; and
transferring consumer activity-related data to a non-merchant storage device.

16. The method of claim 15, further comprising accepting a membership application from the referred consumer.

17. The method of claim 15, wherein transferring consumer activity-related data to a merchant storage device includes transferring consumer activity-related data to a merchant magnetic media having a database structure, and transferring consumer activity-related data to a non-merchant storage device includes transferring consumer activity-related data to a non-merchant magnetic media having a database structure.

18. A computer-assisted marketing method, comprising:
identifying a referrer making a referral to content on the world wide web;
correlating world wide web activity of a referred consumer to the referrer; and
calculating compensation due the referrer for the world wide web activity of the referred consumer.

19. A computer-assisted marketing method, comprising:
identifying a referrer;
correlating a referred consumer and the referrer that referred the consumer;
receiving information regarding contact the consumer has with at least one merchant;
calculating compensation due the referrer for the contact with the at least one merchant;
transferring data related to the consumer contact with the at least one merchant to a merchant storage device; and
transferring data related to the consumer contact with the at least one merchant to a non-merchant storage device.

20. A marketing system, comprising:
a processor; and
a memory device in communication with said processor, the memory device having data and instructions stored thereon which, when executed by said processor, cause said processor to:
identify a referrer;
correlate a referred consumer and the referrer that referred the consumer;
receive information regarding contact the consumer has with at least one merchant;
calculate compensation due the referrer for the contact with the at least one merchant;
transfer data related to the consumer contact with the at least one merchant to a merchant storage device; and
transfer data related to the consumer contact with the at least one merchant to a non-merchant storage device.

21. A marketing system, comprising:
a web server, including:
a member registration module
a member referral module;
a member compensation module; and
a member reporting module; and
a database in communication with said web server, said database storing a plurality of data used by said web server for operation of the system.

22. A collection of objects for a marketing system, comprising:
a member registration object;
a member referral object;
a member compensation object; and
a member reporting object.

23. A computer-readable medium having stored thereon instructions which, when executed by a processor, cause said processor to:
identify a referrer;
correlate a referred consumer and the referrer that referred the consumer;
receive information regarding contact the consumer has with at least one merchant;
calculate compensation due the referrer for the contact with the at least one merchant;
transfer data related to the consumer contact with the at least one merchant to a merchant storage device; and
transfer data related to the consumer contact with the at least one merchant to a non-merchant storage device.

24. An apparatus, comprising:
means for identifying a referrer;
means for correlating a referred consumer and the referrer that referred the consumer;
means for receiving information regarding contact the consumer has with at least one merchant;
means for calculating compensation due the referrer for the contact with the at least one merchant;
means for transferring data related to the consumer contact with the at least one merchant to a merchant storage device; and
means for transferring data related to the consumer contact with the at least one merchant to a non-merchant storage device.
